(19) United States
(12) Patent Application Publication
(10) Pub. No.: US 2009/0274055 A1
(43) Pub. Date: Nov. 5, 2009

(54) Method for Determining a Route in a Network and a Quality-Related Parameter for Said Route

(76) Inventors: Matthias Kutschenreuter, Munchen (DE); Christian Schwingenschlögl, Putzbrunn (DE)

Correspondence Address: STAAS & HALSEY LLP, SUITE 700, 1201 NEW YORK AVENUE, N.W., WASHINGTON, DC, 20005, US

(21) Appl. No.: 12/225,817

(22) PCT Filed: Jan. 26, 2007
(86) PCT No.: PCT/EP2007/050798

§ 371 Date: Sep. 30, 2008

(30) Foreign Application Priority Data
Mar. 30, 2006 (DE) 10 2006 014 911.4

(51) Int. Cl. H04L 12/26

(52) U.S. Cl. 370/248

(57) ABSTRACT

A routing method for a network burdens the network with less routing messages. According to said method, routing hellos for calculating the link metrics are used. The method thus removes the need for metric beacons.

### CROSS REFERENCE TO RELATED APPLICATIONS

This application is based on and hereby claims priority to German Application No. 10 2006 014 911.3 filed on Mar. 30, 2006 and PCT Application No. PCT/EP2007/050798 filed on Jan. 26, 2007, the contents of which are hereby incorporated by reference.

### BACKGROUND OF THE INVENTION

The invention relates to a method for determining a path in a network and a quality value for the path and a network node.

A network allows the routing of messages between its network nodes. However in a network not all the network nodes of the network are connected directly to all the further network nodes. A message from a sending network node to a receiving network node must therefore generally be forwarded by way of one or more intermediate nodes, to get from the sending network node to the receiving network node. The journey from the sending network node by way of the intermediate nodes to the receiving network node is hereby known as the path or route.

In order to select a suitable path for a message from a large number of theoretically possible paths in the network, a routing method is used in conjunction with a routing metric.

The routing method first determines at least one but expediently a plurality of candidate paths, along which the message could be routed.

A path distance value or so-called route metric is assigned to the candidate paths by the routing metric. The path distance value is a measure of the quality of a candidate path. The path distance value in turn can be determined from link distance values for example, which in turn are a measure of the quality of individual links of the respective candidate path. The direct connection between two network nodes of the network is referred to as a link here. A known routing method is for example AODV (Ad-hoc On-demand Distance Vector).

Utilization costs for a link in the path and/or the number of links in a path can be taken into account in the path distance value. It is also possible additionally or alternatively to take into account values for a transmission quality along the candidate path or a link in the candidate path and/or values for the transmission speed of the candidate path or a link in the candidate path. The candidate path with the optimum path distance value is then selected as the path. The message can now be routed along this path.

Methods for determining the path distance value are referred to as routing metrics. One known routing metric is ETX (Expected Transmission Count). With the routing metric ETX the path for which the anticipated number of transmissions is lowest is selected. Transmissions here include both first transmissions and also repeat transmissions or retransmissions. A first transmission is the transmission of a packet by way of a link. A retransmission takes place if the first transmission was unsuccessful. To determine the link distance values with ETX, data packet arrival rates are used, which are determined by the two network nodes associated with the respective link. Metric messages, known as beacons, are sent at regular time intervals to determine the data packet arrival rates.

The known combinations of routing method and routing metric have the disadvantage that they load the network with additional messages.

### SUMMARY

One potential object is to specify an improved method for determining a path in a network and a quality value for the path and a network node, which requires a smaller number of messages for its implementation or operation.

The inventors propose a method for determining a path in a network and a quality value for the path, comprising a routing method for determining the path and a routing metric for determining the quality value, routing test messages, in particular so-called routing hellos, are sent at definable time intervals from at least one network node of the network in the context of the routing method. Also at least one data packet arrival rate is determined for at least one link in the path to determine the quality value of the path and the data packet arrival rate is determined based on at least one of the routing test messages.

The routing test messages can be so-called AODV hellos for example. They can be used for example to determine or notify adjacent network nodes.

The data packet arrival rate indicates the probability of a packet reaching its destination. The data packet arrival rate can for example be the quotient of a of routing test messages received within a time interval to routing test messages actually sent within the time interval.

The method means that it is no longer necessary to send beacon messages. This means that the message load on the network is reduced.

Preferably when determining the path at least one route determination message, in particular a route request message, is broadcast from at least a first network node and the route determination message contains information about a hitherto determined part of the path and about a data packet arrival rate of the first network node in respect of messages from a previous network node of the part of the path.

The network node is embodied to implement a method for determining a path in a network by a routing method and a quality value for the path by a routing metric and has a transmit/receive facility for receiving routing test messages of the routing method and a processing facility. The processing facility is embodied in such a manner that a determination of at least one data packet arrival rate is carried out for a link between the network node and the further network node, to determine the quality value based on at least one routing test message sent from a further network node.

Routing test messages are preferably sent from the network node at definable time intervals.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a section of a network

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

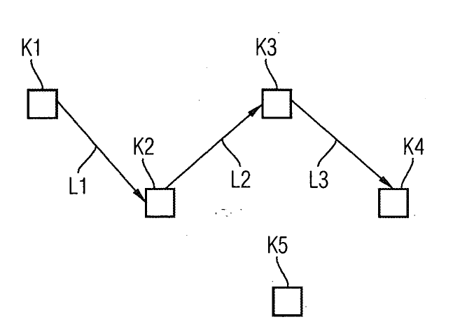

FIG. 1 shows an exemplary section of a network, having a first to fifth network node K1 . . . 5. FIG. 1 also shows a first link L1 between the first network node K1 and the second network node K2, a second link L2 between the second network node K2 and the third network node K3 and a third link L3 between the third network node K3 and the fourth network node K4. The three links L1 . . . 3 form a path from the first network node K1 to the fourth network node K4. The links L1 . . . 3 shown as arrows indicate the respective transmission direction used for the path. The transmission directions are from the first network node K1 to the second network node K2 for the first link L1, from the second network node K2 to the third network node K3 for the second link L2 and from the third network node K3 to the fourth network node K4 for the third link L3.

In the exemplary embodiment of the invention the routing protocol AODV (Ad-hoc On-demand Distance Vector) is used as a basis. With AODV the network nodes K1 . . . 5 send so-called hello messages at regular intervals, in this instance 1 second. Also AODV uses RREQ messages (RREQ=Route Request Packet) and RREP messages (RREP=Route Reply Packet) when determining a candidate path.

On the one hand the hello messages serve to determine adjacencies between the network nodes K1 . . . 5. The network nodes K1 . . . 5 of the network also determine data packet arrival rates from the hello messages. If for example the second network node K2 receives nine out of ten of the hello messages from the first network node K1, it determines the data packet arrival rate for the first link as 9/10=90%. In this example the data packet arrival rates for the first two links L1, L2 are 90% respectively, while the data packet arrival rate for the third link L3 is 70%. The data packet arrival rates here relate to the respective transmission direction of the link L1 . . . 3. The values are referred to below as the data packet arrival rates in the transmission direction.

A respective data packet arrival rate is therefore also determined for the respective other transmission direction of one of the links L1 . . . 3. The data packet arrival rates for the two transmission directions can differ from one another. The values for these, which are to be 80% for the first link L1, 90% for the second link L2 and 70% for the third link L3, are referred to below as data packet arrival rates in the other transmission direction.

In this example the first network node K1 intends to send a message to the fourth network node K4. It is assumed that the first network node K1 does not yet know the path to the fourth network node K4 and must therefore determine it. To this end RREQ messages are sent, which reach the fourth network node K4 by way of the second and third network nodes K2, K3. The fourth network node K4 in turn responds with an RREP message, which is routed back to the first network node K1.

In this embodiment of the invention the data packet arrival rates for the three links L1 . . . 3 are transmitted back to the first network node K1 along with the RREP message. The first network node K1 can in turn determine a route metric for the path from the data packet arrival rates thus transmitted and can select a suitable path, if it has determined other paths to the fourth network node K4.

The route metric can be determined for example using one of the following formulas:

$$\begin{matrix}R = {\prod }_{Links} LM = {\prod }_{Links} ( {D}_{r} \times {D}_{f} ) & ( 1 ) \\ R = {\prod }_{Links} ( {D}_{r}^{2} ) & ( 2 ) \\ R = {\sum }_{Links} \frac{1}{D} & ( 3 )\end{matrix}$$

where:
R route metric
LM link metric
Dᵣ data packet arrival rate in transmission direction
D_{f} data packet arrival rate in other transmission direction
Links number of links

With the numerical examples the following route metric results according to the first formula (1) R=0.9×0.8×0.9×0.9×0.7×0.7=0.29, using the second formula (2) R=0.9×0.9×0.9×0.9×0.7×0.7=0.32. When the third formula (3) is used, R=3.7 results.

If the first or second formula (1), (2) is used to determine the route metric, the path with the biggest route metric is the optimum path. When the third formula (3) is used, the path with the smallest route metric is the best path.

A second embodiment of the invention results, when the link metrics are forwarded with the RREQ messages. In this instance the fourth network node K4 can already decide about the path to be used based on the link metrics transmitted with the RREQ messages.

It should be noted here that RREQ messages are broadcast, unlike RREP messages. This means that the respective sending network node K1 . . . 5 does not know which of the other network nodes K1 . . . 5 will receive the RREQ message. This means that the link metric for a link crossed by the RREQ message can only be indicated by the network node receiving this RREQ message in each instance.

According to the procedure in the related art the network nodes K1 . . . 5 transmit their respective data packet arrival rates respectively to their adjacent network nodes K1 . . . 5 in the beacon messages, so that each network node K1 . . . 5 knows the data packet arrival rates not only for one transmission direction of the links to its neighbor but for both transmission directions.

Since beacons are not used in the inventive method however, the network nodes K1 . . . 5 only know the respective data packet arrival rate in their direction.

It is therefore not possible in this second embodiment of the invention to use the first formula (1) to determine the route metric. Only the second and third formulae (2), (3) can be used, as these only use the respectively available data packet arrival rate.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-5. (canceled)

6. A method for analyzing a data packet transmission path in a network, the path extending from a transmitting node to a receiving node through at least one intermediate node such that the path has at least two links, the method comprising:
sending routing hellos as routing test messages at definable time intervals from at least one node of the network; and
determining a data packet arrival rate for at least one link in the path to determine a quality value of the path, the data packet arrival rate being determined based on successful transmission of the routing hellos.

7. The method as claimed in claim 6, wherein
a preceding node precedes the transmitting node on the path, and
a route request message is broadcast from the transmitting node, the route request message containing information about a hitherto determined part of the path preceding the transmitting node and about a data packet arrival rate at the transmitting node with respect to messages received from the preceding node.

8. The method as claimed in claim 6, wherein the data packet arrival rate for the intermediate node is not transmitted to the transmitting node and the receiving node.

9. The method as claimed in claim 6, wherein
data packets arrive at the intermediate node from both the transmitting node and the receiving node, and
the data packet arrival rate for the intermediate node is determined for both data packets arriving from transmitting node and data packets arriving from receiving node.

10. The method as claimed in claim 7, wherein the data packet arrival rate for the intermediate node is not transmitted to the transmitting node and the receiving node.

11. The method as claimed in claim 10, wherein
data packets arrive at the intermediate node from both the transmitting node and the receiving node, and
the data packet arrival rate for the intermediate node is determined for both data packets arriving from transmitting node and data packets arriving from receiving node.

12. A network node connected to a preceding network node via a link in a potential data packet transmission path, the network node comprising:
a transmit/receive facility to receive hellos as routing test messages from the preceding network node; and
a processing facility to determine a data packet arrival rate for data packets received on the link from the preceding network node, the data packet arrival rate being determined based on successful transmission of the routing hellos, the data packet arrival rate being used to determine a quality value for the path.

13. The network node as claimed in claim 12, wherein the routing hellos are repeatedly sent at a definable time interval.

14. The network node as claimed in claim 12, wherein
the network node has preceding and succeeding network nodes, and
the data packet arrival rate for is not transmitted to the preceding and succeeding network nodes.

15. The network node as claimed in claim 12, wherein
the network node has preceding and succeeding network nodes, and
data packets arrive from both the preceding and succeeding network nodes, and
the data packet arrival rate is determined for both data packets arriving from preceding network node and data packets arriving from succeeding network node.

16. The network node as claimed in claim 13, wherein
the network node has preceding and succeeding network nodes, and
the data packet arrival rate for is not transmitted to the preceding and succeeding network nodes.

17. The network node as claimed in claim 16, wherein
data packets arrive from both the preceding and succeeding network nodes, and
the data packet arrival rate is determined for both data packets arriving from preceding network node and data packets arriving from succeeding network node.

18. A network comprising:
a plurality of network nodes each connected to a preceding network node via a link in a potential data packet transmission path, each network node comprising:
a transmit/receive facility to receive hellos as routing test messages from the preceding network node; and
a processing facility to determine a data packet arrival rate for data packets received on the link from the preceding network node, the data packet arrival rate being determined based on successful transmission of the routing hellos; and
a device to determine a quality value for the data packet transmission path based on the data packet arrival rates from the plurality of network nodes.
